(19) United States
(12) Patent Application Publication
(10) Pub. No.: US 2021/0144170 A1
(43) Pub. Date: May 13, 2021

(54) SYSTEM AND METHOD FOR PROTECTION AGAINST SIDE CHANNEL ATTACKS

(71) Applicant: Indian Institute of Science, Bangalore (IN)

(72) Inventors: Vinod Ganapathy, Bangalore (IN); Arkaprava Basu, Bangalore (IN); Sujay Yadalam Sudarshan, Bangalore (IN)

(21) Appl. No.: 17/092,471

(22) Filed: Nov. 9, 2020

(30) Foreign Application Priority Data
Nov. 9, 2019 (IN) 201941045663

(51) Int. Cl. H04L 29/06; H04L 9/32; H04L 9/14; G06F 3/06; G06F 12/0802

(52) U.S. Cl. CPC H04L 63/1441; H04L 9/3242; H04L 9/14; G06F 3/065; G06F 2212/60; G06F 12/0802; G06F 3/0679; G06F 3/0676; G06F 3/0677; G06F 3/062

(57) ABSTRACT

A method for preventing a side channel attack by executing an enclave on a remote computing device. The method comprises configuring the enclave based on configuration parameters defined by a computing device. A page created in first enclave cache memory in the remote computing device and adding virtual page address information and page security attributes corresponding to the page in a second enclave cache memory, and an encrypted log entry is created in a protected memory of the remote computing device. The enclave is initiated by comparing the log entry and a second hash key generated by the remote computing device. A new page of pre-defined size is dynamically added to the first enclave cache memory after initiation of the enclave. The enclave is executed based on a successful validation of a size of the page created in first enclave cache memory to be equal to the pre-defined page size.

### FIELD

The present disclosure relates to the field of network security, and more specifically, though not exclusively to, a system and method for enabling network security in a trusted execution environment.

### BACKGROUND

Background description includes information that may be useful in understanding the present invention. It is not an admission that any of the information provided herein is prior art or relevant to the presently claimed invention, or that any publication specifically or implicitly referenced in prior art.

On public cloud computing platforms, cloud providers own and administer system software (e.g., the BIOS, the OS, and/or the hypervisor) that manages the computing infrastructure. Such system software is privileged and beyond control of clients of the platform, who must, therefore, entrust the cloud provider with protection of confidentiality and integrity of their data. However, this situation may not be acceptable to many clients, who may not completely trust the cloud provider for a variety of reasons e.g., because of the threat of government subpoenas to the cloud provider, or the cloud provider itself being malicious. Recent advancements in hardware aim to address this situation by allowing clients to protect their confidentiality and integrity even in presence of adversarial system software.

Trusted Execution Environments (TEE) allow clients to create enclaves and provision them with code and data that they wish to protect. TEE ensures that the contents of enclaves are integrity protected and are opaque to even privileged system software by using hardware-managed keys and related hardware enhancements. Thus, from the client's perspective, the Trusted Computing Base (TCB) in the cloud infrastructure includes only the processor, unlike the traditional cloud platforms today. However, conventional TEE relies on system software to manage enclave memory. For example, the system software manages memory for the enclave even though it cannot access the clear text contents of pages in an enclave. Thus, the OS/hypervisor is responsible for servicing page faults and setting up page table mapping between an application's virtual address and the physical address in the enclave memory.

Recent works have demonstrated that this reliance on system software for managing enclave resources can allow subtle side-channels to develop that can leak enclave secrets to system software. In particular, it has been shown that a malicious OS/hypervisor can manipulate meta-data bits in the page table entries (PTEs) of an enclave to reveal the virtual page numbers being accessed within the enclave. This page access sequence is often sufficient to compromise the confidentiality of enclave data. For example, a secret value used in a conditional branch within the enclave may determine the next set of instructions to be executed. If the instructions for the true and false branches lie on different pages, then the page access sequence could reveal some information about the secret being used in the conditional. Adversarial system software could track these page access sequences for enclave code by inducing a page fault each time the enclave accesses a new page. The OS/hypervisor could then note the page number as it services the fault. More advanced variants of these attacks work by simply observing the set of pages accessed during enclave execution e.g., using the access and dirty bits in the page table entries, without inducing page faults. These page address based attacks by malicious system software are now considered a powerful side-channel.

A commonly used TEE is the Intel SGX SDK and the associated SGX device driver (which implements page mapping for enclaves), which fundamentally assume 4 KB page size in mapping enclave memory. All operations that copy memory in and out of the enclave, as well as encryption/decryption and integrity checking, are performed assuming base 4 KB page size. However, the current interface to the SGX device driver does not allow enclave applications to specify their desired page size, instead of assuming 4 KB as the standard. Further, the enclave application may request a large page, the SGX device driver, which runs as part of the untrusted and potentially adversarial system software, cannot be trusted to provide one. Furthermore, in prior art, there is no guarantee from the hardware to the application that a given memory is mapped using a large page. It has been observed that the hardware while walking the page table in the course of performing the address translation, learns the page size used to map a given virtual address region. Additionally, security mechanisms often come at the cost of performance and can lead to page address-based side channels.

Many techniques have been developed to defend against side channel attacks, but more effective ways are needed as information processing system development continues. Therefore, there exists a requirement for an efficient, effective and improved system and method to configure large pages for enclave code and/or data, which can vastly reduce the number of distinct page addresses in the stream observable to an attacker.

### SUMMARY

The present disclosure relates to the field of network security, and more specifically, though not exclusively to, a system and method for enabling network security in a trusted execution environment.

According to an aspect of the present disclosure, a method for preventing side channel attacks is provided for executing an enclave in a trusted execution environment (TEE) on a remote computing device by a computing device. The method comprises configuring the enclave by executing a first set of instructions based on configuration parameters defined by the computing device, wherein the configuration parameters comprises a pre-defined page size. Further, implementing a second set of instructions to: securely copying data corresponding to the enclave in a page created in first enclave cache memory in the remote computing device, based on the plurality of configuration parameters, adding virtual page address information and page security attributes corresponding to the page in a second enclave cache memory in the remote computing device, and creating a log entry in a protected memory of the remote computing device by encrypting and saving the virtual page address information and the page security attributes, wherein the virtual page address information and the page security attributes are encrypted using a first hash key. A new page of the pre-defined size is dynamically added to the first enclave cache memory after the initiation of the enclave.

Further, the enclave is initiated by executing a third set of instructions by compare the log entry and a second hash key generated by the remote computing device and executing the enclave at the remote computing device, by executing a fourth set of instructions based on a successful comparison of the log entry and the second hash key wherein the successful comparison is based on a validation of a size of the page created in first enclave cache memory in the remote computing device to be equal to the pre-defined page size.

According to an embodiment, the confirmation parameter defines the pre-defined pages size of 2 GB.

According to an embodiment, the first hash key is computed by executing a fifth set of instructions based on the pre-defined page size and a content associated to the page.

According to an embodiment, the second hash key is created by the remote computing device based on at least one of the configuration parameters.

According to an embodiment, the second hash key is created based on at least one of the configuration parameters comprising a page size, the virtual page address information and the security attributes.

According to an embodiment, the configuration parameters comprises a mapping between the virtual page address information of one or more pages created and the first enclave cache memory.

According to an embodiment, the remote computing device generates the virtual page address information based on the mapping included in the configuration parameters when the enclave is initiated.

According to an embodiment, the new page is added in the first enclave cache memory by executing a sixth set of instruction after the initiation of the enclave. In an embodiment, the new page is created in a pending state and is accepted by the enclave by executing a seventh set of instruction.

According to an embodiment, the comparison is successful based on a validation of a size of the page created in first enclave cache memory in the remote computing device to be equal to the pre-defined page size.

According to another aspect of the present disclosure, a system for executing an enclave in a trusted execution environment to prevent a side channel attack is provided. The system comprising a client computing device communicably connected to a remote computing device implementing the trusted execution environment; wherein the client computing device comprises a memory and a processor configured to configure the enclave by executing a first set of instructions based on a plurality of configuration parameters defined by the computing device, wherein the plurality of configuration parameters comprises a pre-defined page size implement a second set of instructions to securely copy data corresponding to the enclave in a page created in first enclave cache memory in the remote computing device, based on the plurality of configuration parameters, add virtual page address information and page security attributes corresponding to the page in a second enclave cache memory in the remote computing device, and create a log entry in a protected memory of the remote computing device by encrypting and saving the virtual page address information and the page security attributes, wherein the virtual page address information and the page security attributes are encrypted using a first hash key. The system then initiates the enclave by executing a third set of instructions to compare the log entry and a second hash key generated by the remote computing device. A new page is dynamically added of the pre-defined size to the first enclave cache memory after the initiation of the enclave. The enclave is executed at the remote computing device, by executing a fourth set of instructions based on a successful comparison of the log entry and the second hash key, wherein the success of the comparison is based on a validation of a size of the page created in first enclave cache memory in the remote computing device to be equal to the pre-defined page size.

The present invention proposes a novel system that significantly increases the difficulty of any page access-based side-channels via the use of large pages. A large page maps virtual address to physical address at a much larger granularity than the default page size (at least 512 times larger). The present invention uses large pages and lowers resolution of the leaked page address stream, thereby severely weakening the attacks demonstrated in prior works. In the present invention modifications needed to SGX's software stack and the (minor) hardware enhancements required providing a robust defence even in the presence of an adversarial system software. The proposed invention can be one of those rare systems that enhance security with the potential of improving performance as well. The use of large pages can assume further importance for SGX2.0, which is likely to increase the amount of physical memory allocated for enclaves significantly.

The present invention focuses on the Intel SGX a set of hardware and software extensions that provides support for enclaves, which can be used to build a number of novel security applications. The present invention includes a system approach to defend against the aforementioned side-channel by reducing the resolution of the page access stream and consequently, reducing the effectiveness of the side-channel attacks. The proposed system proposes to use large pages for enclave code and/or data, which vastly reduce the number of distinct page addresses in the stream. The present invention builds the software stack for and demonstrate the effectiveness of using large pages to thwart page-address based side-channels on Intel SGX. The present invention presents the necessary (minor) enhancements to the Intel SGX hardware to reliably enforce the use of large pages within the enclave.

Various objects, features, aspects, and advantages of the present disclosure will become more apparent from the following detailed description of preferred embodiments, along with the accompanying drawing figures in which like numerals represent like features.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1a illustrates exemplary major components of a SGX's enclave creation at a remote hardware platform, in accordance with an exemplary embodiment of the present disclosure.

FIG. 1b illustrates a table showing the number of page faults observed by the adversary during a processing by the enclave, in accordance with an exemplary embodiment of the present disclosure.

FIG. 2 illustrates exemplary functional components of the remote computing system 100 in accordance with an embodiment of the present disclosure.

FIG. 3 illustrates the steps involved in enclave creation as illustrated in FIG. 1, in accordance with an embodiment of the present disclosure.

FIG. 4 illustrates an exemplary SGX component, in accordance with an exemplary embodiment of the present disclosure.

FIG. 5 illustrates an exemplary implementation of proposed large page defence architecture, in accordance with an exemplary embodiment of the present disclosure.

FIG. 6 illustrates the steps implemented to implement the proposed large page defence architecture, in accordance with an exemplary embodiment of the present disclosure.

FIG. 7, illustrates a table depicting an evaluation of Applications ported to run within SGX enclaves, in accordance with an embodiment of the present disclosure.

FIG. 8 depicts a table how applications are attacked and how the numbers in the shows the efficacy of SGXL using an empirical security analysis for SGXL, in accordance with an embodiment of the present disclosure.

FIG. 9a illustrates an exemplary graph of speedup with SGXL under attack, in accordance with an exemplary embodiment of the present disclosure.

FIG. 9b illustrates an exemplary graph of speedup with SGXL without attack, in accordance with an exemplary embodiment of the present disclosure.

FIG. 9c illustrates an exemplary graph projecting for larger EPC sizes with 1 GB page size, in accordance with an exemplary embodiment of the present disclosure.

FIG. 9d illustrates an exemplary graph of approximation of PAO by the SGXL using FreeType, in accordance with an embodiment of the present disclosure.

FIG. 9e illustrates an exemplary graph of approximation of PAO by the SGXL using Libjpeg, in accordance with an embodiment of the present disclosure.

FIG. 9f illustrates an exemplary graph of approximation of PAO by the SGXL using Hunspell, in accordance with an embodiment of the present disclosure.

FIG. 9g illustrates a table presenting the results for performance of SGXL and PAO for FreeType, Libjpeg and Hunspell, in accordance with an embodiment of the present disclosure.

FIG. 10 is a high-level flow diagram illustrating working of the system in accordance with an embodiment of the present disclosure.

FIG. 11 illustrates an exemplary computer system to implement the proposed system in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

The present disclosure relates to information processing, and more specifically, to a system and method that uses large pages to map enclave virtual addresses that dramatically reduces resolution of page-address access stream observable to an attacker.

Unlike prior works, the present invention extends the potentially adversarial system software to provide a service (allocation of large pages) that enhances the security. Proposed instruction set extension (hardware) makes the service non-bypassable by the adversary. A hardware and software co-design to enable this defence is unique and has not been considered before.

The present disclosure provides a system and method to use large pages to reduce resolution of page address access stream observable to an attacker using an improved hardware and software co-designed trusted execution environment (TEE). Particularly, an embodiment of the disclosure is described using Intel SGX as a TEE. It would be appreciated to persons skilled in the art that a similar approach to the one described as an embodiment of the disclosure may be applicable to other TEE platforms.

Modern Intel processors with SGX support are widely deployed across cloud infrastructure and user computing nodes. All these processors suffer from well-known vulnerability due to page-based side-channel attacks on its SGX capabilities. The proposed invention proposes a method to defend against this vulnerability. The proposed invention is thus applicable to any modern Intel processor. Furthermore, the required changes to the hardware and software are minimal and thus facilitating an ease in deployment of the same.

FIG. 1 illustrates exemplary major components of a SGX's enclave creation at a remote computing hardware platform 100, in accordance with an embodiment of the present disclosure.

In an embodiment, SGX enables clients of remote cloud platforms to ensure the confidentiality and integrity of their sensitive code and data. It does so by allowing sensitive portions of an application to run inside a hardware-protected execution environment called enclave on a cloud platform. The hardware ensures that enclave's contents are protected even in presence of malicious privileged system software in the cloud. There are two primary components to SGX. First, the remote hardware 102 (e.g., an SGX-based cloud platform) needs to gain the confidence of the client by using a hardware attestation protocol. The remote hardware 102 then verifies the integrity of its secrets (sensitive code and/or data) 104 to the client though signature matching. Second, the remote hardware 102 ensures that application's secrets provisioned within the enclave are opaque and integrity-protected against any malicious software, including privileged system software. As shown in FIG. 1, the region depicted with light grey shade is secured by SGX and the region depicted with dark grey is unsecured.

In an embodiment, the client may be connected to a cloud platform via a network which can be a wireless network, a wired network, or a combination thereof. The network can be implemented as one of the different types of networks, such as intranet, local area network (LAN), wide area network (WAN), the internet, Wi-Fi, LTE network, CDMA network, and the like. Further, the network 108 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network can include a variety of network devices, including routers, bridges, servers, computing devices, storage devices, and the like.

In order to gain the confidence of clients by using a hardware attestation protocol, the SGX's software development kit (SDK) provides the client with a trusted signing tool to help compute a signature (hash) of the application's binary and data. This signature is sent to the remote hardware 102 over an authenticated channel as part of a structure called SIGSTRUCT. In an embodiment, integrity of application binary/data is verified to the client by the remote hardware 102. The second component of SGX involves the remote cloud platform 100 with SGX-capable processors. On a system start-up, a contiguous memory region, referred to as the Processor Reserved Memory (PRM) 108 is set aside for enclaves in a Physical Memory 106. The PRM region 108 is split into two parts the Enclave Page Cache (EPC) 110 and the Enclave Page Cache Map (EPCM) 112. The client application's sensitive code and data 104 are loaded into the EPC 110 before enclave execution starts. The EPCM 112 contains the metadata (e.g., ownership, addresses, type, permissions) to track the contents of the EPC 110 at 4 KB page granularity. The EPCM 112 region is accessible only to the hardware.

In an embodiment, the SGX hardware also ensures that any malicious system software has not fiddled with the mapping between enclave's virtual address space 116 and the EPC 110.

In an embodiment, the software accesses memory using virtual addresses, which are then translated to physical addresses pointing to real locations where the code and/or data reside. While hardware typically performs the address translation, the system software is responsible for creating mappings from virtual to physical addresses. Address mappings are maintained at the granularity of pages (e.g., 4 KB) and are stored in page tables 118, which are organized as four-level radix trees on x86-64 processors. A page table entry (PTE) also contains meta-data information such as the access bit and the dirty bit that are typically used by the system software for page replacement and page write back decisions. An address translation in a four-level page table may require four accesses to an in-memory page table 118. In an embodiment, a hardware page table walker (PTW) typically performs the translation by walking the page table 118. However, a page table walk on every load/store would add large performance overhead. Hardware designers thus introduced Translation Lookaside Buffers (TLBs) that cache recently used address translation entries at each CPU core. A hit in the TLB obviates a page table walk. However, a TLB miss requires a long latency page table walk to refill the missing entry. Thus, TLB miss rate determines the address translation overhead that an application experiences. Adding more entries to the TLB could reduce miss rate but is often too expensive. Since TLBs are hardware structures that can be accessed on every load/store, they need to meet strict latency and power budgets, which larger TLBs may be unable to. An alternative way to reduce TLB misses is to arrange for a TLB entry to map a larger range of contiguous virtual addresses to contiguous physical address. The same number of TLB entries can then map a larger fraction of application's memory footprint. This is the primary motivation behind the use of large pages. It has been shown that large pages can reduce the execution time of memory-intensive applications by 10-18%. In x86-64 processors, the instruction set architecture defines two large page sizes 2 MB and 1 GB. The specific sizes of large pages depend on the page table structure.

Applications (inside or outside the enclave) use the default page size of 4 KB to map virtual addresses to physical addresses in x86-64 based processors, including those from Intel. However, a large body of work has demonstrated that the overhead of translating virtual addresses to physical addresses can account for up to 51% of execution cycles for applications with large memory footprint. Modern processors thus allow system software the choice of mapping memory at a larger granularity of 2 MB or 1 GB (called large pages) to reduce address translation overheads. Page table entries for large pages cover a significantly larger chunk of the virtual address space e.g., 512 for 2 MB pages than with traditional 4 KB pages. In turn, fewer large page entries in the translation lookaside buffer (TLB) could cover address mappings of application's memory footprints. This typically lowers misses in the TLB and consequently, reduces address translation overheads.

In an embodiment, the system software may specify the page size to map a given virtual address range. Applications can request large pages via system calls. OSes also enable application-transparent allocation of large pages. Page size information is encoded in the page-size bit in a PTE.

In an embodiment, a SGX driver is responsible for creating and maintaining PTEs to map an enclave's virtual address to physical memory. On a system start-up, the BIOS sets aside a contiguous physical memory for the EPC region 110. When a client application creates an enclave, the SGX driver maps that enclave's virtual pages to physical page frames drawn from the EPC 110. Since the driver is not trusted, it is essential for the hardware to ensure that a malicious or buggy driver has not altered the address mappings. This goal is achieved in two steps. First, as previously mentioned, the translation information is added to the EPCM 112 as soon as a page is added to the EPC 110 by executing the eadd instruction (2). The software cannot access the contents of EPCM 112. Second, before filling a TLB entry after a page table walk, the SGX hardware checks the integrity of results of the walk (i.e., a PTE) against the corresponding entry in the EPCM 112. On a mismatch, the SGX hardware raises an exception and exits the enclave. While the SGX driver cannot alter address mappings, it still can modify the meta-data in a PTE. For example, it can toggle the present bit that indicates the presence of data pointed by the PTE in the memory. Access to a page whose present bit is unset triggers a page fault. This flexibility enables the driver to evict pages from the EPC 110 under memory pressure. However, this very flexibility allows the driver to induce page faults during the execution of an enclave. The stream of falsely induced page fault addresses could be exploited by a malicious driver to infer secrets. Furthermore, meta-data bits such as the access bit and the dirty bit of a PTE is under driver control and can be used to infer secrets without even introducing false page faults.

In an embodiment, in a threat model, the objective of SGX is to protect the enclave from potentially adversarial system software. In an exemplary embodiment, the OS/hypervisor may be under the control of the adversary and that the enclave only trusts the processor. Because the adversary controls the OS/hypervisor, it can arbitrarily modify page table entries belonging to the enclave, and consequently can arbitrarily induce page faults during enclave execution. SGX ensures that the adversary cannot observe the clear text contents of enclave pages 104, because the hardware encrypts their contents whenever they exit the processor package. However, the adversary's ability to interrupt enclave execution and observe/modify page table entries serves as a powerful side-channel. This family of attacks works by using the side-channel to observe the sequence (or set) of virtual pages accessed by the enclave and using this observation to infer secrets processed by the enclave. In an exemplary scenario, a library FreeType which renders TrueType fonts onto bitmaps is attacked. Assuming that the text (here, a character) being rendered is the secret. The goal of the attack is to infer the text by simply observing the page fault address stream corresponding to the enclave. FreeType's code compiles to a size of 1.5 MB, thereby occupying close to four hundred 4 KB pages. For each input character that FreeType processes, the logic used depends on the specific properties of the character. The glyph for each character is a collection of lines, curves, and hints, and the code path used depends on these parameters. According to an exemplary snippet shown below:

<rc/truetype/ttgload.c> (Version 2.5.3)
1609: if (loader−>n_contours > 0) {
...
1618: TT_Process_Simple_Glyph( loader );
...
}
1631: else if {
...
1642: face−>read_composite_glyph( loader );
...
}

It is show in the Snippet how the number of contours in a glyph is used to select the processing logic and the structure loader is derived from the input character. The key property to note is that the code that executes for the true branch resides on a different set of pages than the code that executes for the false branch. The adversary can attack FreeType by clearing the present bit for enclave's page table entries. If the enclave attempts to execute code on this page, it can trigger a page fault even if the corresponding physical page resides in the EPC. The adversarial OS is invoked to service the page fault, and in doing so, it can observe the virtual page number that triggered the fault. It sets the present bit, allowing code execution to continue. The present bit remains set until the enclave executes code on another page. At this point, the adversary clears the present bit for the current page (so that a fault is triggered if the code on this page is executed again), and proceeds to service the page fault for the new page. Note that the adversary may observe multiple page faults on a single virtual page number during an execution each time code execution returns to that page from a different page, a fault is triggered. The adversary is thus able to observe and reconstruct the execution of enclave code at the granularity of page numbers. Also, instead of inducing faults on every code page boundary crossing, it is possible to monitor accesses to only a few important code pages, identified using offline code analysis. Table 1: Number of page faults observed by an adversary for various lower-case characters processed by FreeType. For FreeType, it turns out that even observing the total number of page faults during enclave execution is sufficient to determine the input character that was processed.

FIG. 1b illustrates a table showing the number of page faults observed by the adversary during a processing by the enclave, in accordance with an exemplary embodiment of the present disclosure.

FIG. 1b depicts a table showing the number of page faults observed by the adversary as different lower-case English characters were processed by the enclave. As the table shows, each character has a unique “signature” of the number of page faults observed, which is therefore sufficient to reconstruct the input character. Although not necessary for FreeType, the adversary also has access to the precise sequence of page faults observed for code pages as well as for data pages, which provide even more information for the adversary to reconstruct the input. Accordingly, following three techniques have been developed to identify which pages were accessed by the enclave:
Page-faults: the first variant is the method described above. Later the disclosure discusses attacks on other applications where the page faults on data pages are induced. This variant can precisely recover the sequence of page accesses from an enclave.
Accessed and dirty bits: where an adversary can simply observe the access and dirty bits of the page table entries of an enclave and identify the set of pages accessed/modified. They also show that an adversary that periodically resets these bits as an enclave executes (using a parallel thread) can also identify the order in which the enclave accesses the pages. This approach is less intrusive than the first variant because it does not induce page-faults.
Tapping the TLB: It can be possible to infer an application's page access patterns by directly tapping into the TLB. Two hyper threads—one belonging to a user; and the other belonging to an attacker can execute on the same processor core as the TLB. The attacker can infer the victim's page access patterns by implementing a timing side channel using methods similar to those implemented for cache side-channels.
Hooking into address translation: where an adversary can leverage how the hardware looks up the page table to infer page accesses. As previously discussed, on x86-64 systems, the page table walker has to perform up to four memory accesses to translate a virtual address. These accesses can hit the processor's cache hierarchy as the page table contents could be cached like any other data. An adversary can thus leverage the well-known cache-based timing-side-channels (e.g., Flush+Reload or Prime+Probe) to infer which pages were accessed. Having identified the count, sequences, or sets of pages that were accessed by an enclave, an adversary can use this information to infer secrets processed by the enclave. Page fault counts suffice for some benchmarks, such as FreeType.

For other benchmarks, a specific sequence or set of page accesses can indicate that a particular function was invoked or that a particular data structure was accessed. The specifics of this inference are dependent on the application. The proposed threat model precludes an adversary with physical access to the memory bus of the machine. While an adversary that controls the OS/hypervisor can observe the sequence of page numbers, an adversary with physical access can observe full address (including the page offset) of every enclave access. Defences against such physical adversaries are beyond the scope of the proposed invention. The proposed threat model also does not directly address cache-based timing attacks. Such attacks leverage the fact that enclave and non-enclave code share the last-level cache. A detailed study of the impact of large pages on these attacks is beyond the scope of the present invention.

In an embodiment, large pages are used to reduce the effectiveness of page access patterns that a malicious OS or a hypervisor may observe. The use of large pages to map code and/or data 104 of an enclave process decreases the resolution of the page-address stream that an attacker can observe by more than two orders of magnitude. For example, in Intel or AMD processors, a large page is at least 2 MB while the default page size is 4 KB. A 512× reduction in the granularity at which an attacker can observe page accesses vastly reduces the effectiveness of drawing inferences about enclave secrets based on page access pattern observations. Furthermore, the next larger page size is 1 GB, another 512× larger than a 2 MB page size. An over-cautious application can even use 1 GB pages to effectively defeat any page-address based side-channel attack. The use of large pages does not theoretically guarantee defence against page-address-based attacks. Doing so requires ensuring a much more powerful property that of page-access obliviousness, which ensures that the sequence of page access patterns from an application remains the same irrespective of the secrets processed by the enclave. That would require a new layout of code and data for each application and augmenting the type system of the programming language. Importantly, one needs to introduce many dummy memory accesses to balance accesses to pages. Consequently page-access obliviousness is yet to be demonstrated for large, commercial applications. For most practical purposes, the proposed defence is robust. For attacks that rely on page fault count to infer secrets, the defence reduces the number of page faults by multiple orders of magnitude. For attacks that rely on sequences of page fault addresses for inferring secrets, defence reduces the number of unique sequences. In short, this leaves too little information for the attacker to infer the secrets. There are two key challenges in realizing the aforementioned idea.

First, Intel's SGX SDK and the supporting SGX driver assume the use of only the default page size of 4 KB. These entities will be required to be modified to allow enclaves to support multiple page sizes. Second, the hardware needs to provide the guarantee that the SDK and driver are truly providing large pages as desired by the client. This is a necessity since the driver and a part of the SDK are not trusted.

FIG. 2 illustrates exemplary functional components of the remote computing system 100 in accordance with an embodiment of the present disclosure.

In an aspect, the system 100 may comprise one or more processor(s) 202. The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 are configured to fetch and execute computer-readable instructions stored in a memory 204 of the system 102. The memory 204 may store one or more computer-readable instructions or routines, which may be fetched and executed to create or share the data units over a network service. The memory 204 may comprise any non-transitory storage device including, for example, volatile memory such as RAM, or non-volatile memory such as EPROM, flash memory, and the like.

The system 100 may also comprise an interface(s) 206. The interface(s) 206 may comprise a variety of interfaces, for example, interfaces for data input and output devices, referred to as I/O devices, storage devices, and the like. The interface(s) 206 may facilitate communication of system 100. The interface(s) 206 may also provide a communication pathway for one or more components of the processing engine 208. Examples of such components include, but are not limited to, processing engine(s) 208 and database 210.

The processing engine(s) 208 may be implemented as a combination of hardware and programming (for example, programmable instructions) to implement one or more functionalities of the processing engine(s) 208. The processing engine(s) 208 is stored on the memory 206 and runs on the processor(s) 202. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 100 may comprise the machine-readable storage medium storing the instructions and the processing resource to execute the instructions, or the machine-readable storage medium may be separate but accessible to system 100 and the processing resource. In other examples, the processing engine(s) 208 may be implemented by electronic circuitry.

The database 210 may comprise data that is either stored or generated as a result of functionalities implemented by any of the components of the processing engine(s) 208 or the system 100. In an embodiment, the processing engine(s) 208 may include a data driver engine 212 and other engine (s) 214. Other engine(s) 214 can supplement the functionalities of the processing engine 208 or the system 100.

In an embodiment, the driver engine 212, may create and maintain PTEs to map an enclave's virtual address to physical memory. On a system start-up, the BIOS sets aside a contiguous physical memory for the EPC region 110. When a client application creates an enclave, the driver engine 212 may map that enclave's virtual pages to physical page frames drawn from the EPC 110.

FIG. 3 illustrates the steps involved in enclave creation as illustrated in FIG. 1, in accordance with an embodiment of the present disclosure.

In an embodiment, as is illustrated in FIG. 3, the steps include at block 302, issuing of a SGX-specific ecreate (depicted as (1) in FIG. 1) instruction by a software executed by the client to set up the initial environment. In an embodiment, the configuration of an enclave is typically specified by the client.

At block 304, issuing eadd instructions (depicted as (2) in FIG. 1) to copy the application's enclave code and data into the EPC 110 of FIG. 1 at the granularity of 4 KB pages. It also adds an entry in the EPCM 112 of FIG. 1 with the virtual page number and the corresponding security attributes. Further, the virtual address and its security attributes are then hashed and augmented into an SGX-specific hardware register called the MRENCLAVE 114 of FIG. 1.

At step 306, issuing extend instruction (depicted as (3) in FIG. 1) to compute a cryptographic hash of the contents copied into the EPC pages 104 of FIG. 1. This hash is then augmented to the content of MRENCLAVE 114 of FIG. 1.

At step 308, issuing an init instruction (depicted as (4) in FIG. 1) to initialize the enclave, in order to initialize the enclave the hardware compares the content of the MRENCLAVE with the signature sent by the client as part of SIGTRUCT. A match guarantees the integrity of client application's code and data in the enclave. In an embodiment, after enclave initialization, enclave execution can be started, resumed or exited by issuing of SGX-specific eenter, eresume, and eexit commands.

In an embodiment, SGX may load all of the enclave code and data pages into the EPC before the enclave execution starts. This may force the application developers to predetermine the size of stack and heap regions. In an embodiment, SGX may allow dynamic addition of pages to EPC, on demand, and may introduce new instructions such as eaug instruction which may allow an application to add a page to an already initialized enclave. The page may be added in a pending state which can be later be accepted by the enclave using eaccept or eacceptcopy instructions. In consequence, the size of the PRM is expected to significantly increase.

FIG. 4 illustrates an exemplary SGX component, in accordance with an exemplary embodiment of the present disclosure.

In an embodiment, the proposed SGX component modification addresses the challenges underlined earlier. In an embodiment, SGX may be enhanced in the following ways. In proposed execution model, an application writer can specify which segments (e.g., code, heap) of enclave's virtual address space are to be mapped using large pages. For example, if an application is potentially vulnerable to page-address based attacks on the code pages then the code segment can be mapped using large pages inside the enclave. Similarly, if secrets could be inferred from observing page faults on data pages then the application writer can configure the enclave to map heap or data segment using large pages. The trusted signing tool at the client's computer creates a signature by augmenting the hash of the page contents with the hash of the page sizes. This signature is then sent to the remote computer for later verification, via an authenticated channel. The application writer performs these steps at his local computer. On the remote computer (i.e., the SGX-enabled cloud platform), the enhanced SGX driver is expected to map enclave's data and/or code using large pages as configured. During the enclave initialization, the SGX hardware is however, responsible for guaranteeing that the page sizes used to map enclave's virtual addresses are as desired in the configuration since the driver is untrusted. This is achieved by augmenting hardware-computed hash of enclave's contents with that of corresponding page size used for mapping the enclave. This enhanced hash is then compared it against the signature supplied by the client. A match guarantees that correct page sizes are used for mapping enclave's addresses. The hardware further needs to ensure that the page sizes used for mapping enclave's virtual addresses are not altered after enclave initialization. Incidentally, the SGX hardware already performs similar checks during virtual to physical address translation to ensure that the OS/hypervisor has not altered the mapping between enclave's virtual address and the physical address in the EPC. The check is simply extended to also ensure that page size has not been altered.

Based on the above, the SGX components can be modified to create an enhanced version SGXL. The modified portions of the SGX are contained in a dotted line boundary as shown in FIG. 4. The blocks depicted with light grey shade are part of TEE and the region depicted with dark grey is not covered by TEE.

As depicted in FIG. 4, implementing SGXL requires modifications to the SGX SDK 402, linker scripts 404, SGX driver 406 and a few minor enhancements to the hardware. All the changes needed in the software stack and plan to open-source the code. The hardware enhancements are limited to extending one SGX instruction and minor microarchitectural extensions to existing SGX functionalities. However, since these enhancements cannot impact the security evaluation and cannot have any measurable performance impact, the hardware changes or use the simulators for evaluation. The use of a simulator could actually harm evaluation by limiting the type of workloads that can execute and the fidelity of the evaluation.

FIG. 5 illustrates an exemplary implementation of proposed large page defence architecture and FIG. 6 illustrates the steps implemented to implement the proposed large page defence architecture, in accordance with an exemplary embodiment of the present disclosure.

In an embodiment, first piece of the implementation concerns modifications to the SDK 502 in client's local computer 504 (which is trusted, since the client is the code and data owner). According to the implementation at step (a) in FIG. 5 the method can include at block 602: enabling a client to specify which segment(s) or section(s) of an enclave's virtual address space should be mapped using large pages. For example, one could specify the code segment and/or the heap segment in the enclave is mapped using large pages. In an embodiment, all segments can be specified to be mapped using large pages. Enhanced parser then parses this file and passes the information on the use of large pages to the modified linker scripts 506.

At step (b) of FIG. 5 and at block 604: modifying the linker scripts 506 to align the starting virtual addresses of each segment to be mapped using large pages at a large page boundary, here, 2 MB. This is a necessary condition for using large pages. In an embodiment, linker script changes may not be necessary for aligning the heap segment. In an alternate embodiment, the enhanced SDK's enclave creator requests the heap to start at a large page boundary.

At step (c) of FIG. 5 and at block 606: creating an augmented cryptographic hash 508 that takes into account the desired page size. This augmented hash 508 can later be matched with the hash generated by the trusted hardware at the remote SGX-enabled cloud platform. This is required to be able to later guarantee to the client that the system software at the remote platform is using large pages as desired. An enhanced signing tool, implemented by Intel, compute the hash of the virtual address layout along with the corresponding page sizes. More specifically, the enhanced signing tool first creates address space entries by concatenating virtual address ranges with corresponding page sizes, along with other security/permission attributes. It computes the hash 508 (e.g., SHA-256) on these entries and augments the hash 508 to the SIGSTRUCT data structure. SIGSTRUCT 510 is sent to the remote computer for it to be verified against the hardware-computed hash.

In an embodiment, the software, and the hardware at the SGX-enabled cloud platform, may guarantee the use of large pages, in accordance with the modified architecture. The most significant software modification happens in the SGX driver 512. The driver 512 is responsible for mapping certain virtual address ranges with large pages and performs associated management of multiple page sizes inside the enclave's EPC 514.

In an embodiment, the driver may be enhanced in following three ways:
As depicted by step (d) and at block 610: keeping, by the driver 51, a set of 2 MB contiguous physical page frames (besides the default 4 KB page frames) in the designated physical memory 514 of the enclave that could be used to map large pages. By keeping separate free-lists for 2 MB and 4 KB regions. On a request for a large page, the driver returns a physical memory region from the 2 MB list and from the 4 KB list otherwise.
As depicted by step (e) of FIG. 5 and at block 612, issuing by the driver, an enhanced eadd instruction that accepts a page size argument or information. Since the enhanced eadd is not readily available in the current hardware, the present implementation of the driver simulates enhancement by issuing eadd in a loop with 512 iterations to add a large page to the enclave. Similarly, the driver issues extend instruction in a loop to compute the cryptographic hash 516 of large page contents that are added to the MRENCLAVE register 518 for later verification. Further, page size information is added by the eadd instruction in a corresponding EPCM entry 522.
At step (f) of FIG. 5 and at block 614, creating by the driver, appropriate page table entries 520 for enclave's virtual address ranges to be mapped using large pages as appropriate. In an embodiment, the driver's interface (i.e., ioctl ( )) is appropriately extended to include a page size information.

At step (g) of FIG. 5 and at block 616, extending the EPCM entry 522 by 2 bits to hold the page size information.

At step (h) of FIG. 5 and at block 618, computing hash by the eadd instruction, based on newly added virtual page number, along with the page size and augment that to the MRENCLAVE 518.

In an embodiment, during the enclave initialization (i.e., when emit is issued), the content of the MRENCLAVE 518 is matched against that provided in SIGSTRUCT 510 information generated by the signing tool at the client (step (h)), as done by today's SGX hardware. Since SGXL takes into account the page size in computing the hashes, a match ensures that remote cloud platform is using large pages as desired. During execution inside the enclave, the hardware needs to also ensure that page size used to map a given address range is not altered after the enclave is initialized. This can be achieved by minimally extending checks that the current SGX hardware already performs. On a TLB miss, the hardware page table walker locates the desired in-memory PTE. Before populating the TLB the content of this PTE, it checks PTE's integrity with the corresponding EPCM entry. Specifically, it ensures that the malicious system software has not altered the physical address. In the proposed invention, extend this to also verify that the page size matches that in the EPCM. A mismatch can trigger an error. Thus, SGXL ensures that a malicious OS cannot change the page size used for mapping during enclave execution. Note that the page size information is already present in a size bit in the PTE and thus requires no change in the page table format and no changes in the page table walker. Finally, if the hardware page table walker fails to find desired PTE or there is not enough permission in the PTE for the requested operation it needs to raise page fault exception as usual. However, before raising the fault the enhanced page table walker should consult the corresponding EPCM entry. If the page size in the EPCM entry is 2 MB then the hardware should mask out last 21 bits of the virtual address before raising the fault. This is important to hide exact faulting virtual address from the potentially malicious system software. Current SGX hardware masks out only 12 bits of the page offset as it expects only 4 KB pages in the EPC.

In another embodiment, currently available version of Intel's SGX, SGXL can be extended to a version SGX2.0. SGX2.0 can allow demand paging a virtual page can be dynamically mapped to a physical page frame on demand (e.g., on first access). In an embodiment, the implementation of the second objective SGX2.0 may use new instructions such as eaug and eaccept. The eaug instruction can be used dynamically to add a new page after the enclave has been initialized. The eaccept instruction can then be used to ensure the properties of the newly added page are in accordance with the corresponding EPCM entry. To extend large page support to SGX2.0 both these instructions need changes. The eaug instruction should be extended to accept page size information and the instruction should be able to add a page of the desired size to the EPC.

In an embodiment, the semantics of the eaccept instruction may be extended also check the page size information in the corresponding entry in the EPCM. Any mismatch indicates a possible manipulation of page sizes and thus should exit enclave execution with an appropriate exception.

In an embodiment, a system with a processor including but not limited to Intel Core® i7-8700, which may support SGX (v1) which allows an EPC of maximum 128 MB. The system may include but is not to, a 32 GB DDR4-2600 memory and may run an OS including but not limited to Linux 4.14.0.

In another embodiment, applications may be significant modified to be able to make use of enclave execution in SGX. For example, applications cannot invoke system calls from within the enclave.

FIG. 7, illustrates a table depicting an evaluation of Applications ported to run within SGX enclaves, in accordance with an embodiment of the present disclosure. In an embodiment, the table includes a measure of Libjpep and GUPS benchmarks to use enclave execution. The table further includes NBench which has been ported to run within SGX enclaves. It is important to note that the security analysis remains unchanged irrespective of whether the attacks are mounted inside or outside the enclave. The same set of page faults are induced during attack irrespective of whether the application executed inside or outside the enclave. The performance implications may also likely stay the same as any impact due to enclave execution can affect the attack and defence in the same manner. In the proposed invention, three applications (Libjpeg, GUPS and NBench) run within SGX to ensure all parts of software development works as expected. The proposed invention also mounts the attack on two more applications Hunspell, and FreeType outside the enclave. Table of FIG. 7 lists the configuration used to run these applications. The inputs given in the table for each application may be numbers that are reported from either hardware performance counters or through direct wall clock measurements.

In another embodiment, defence against side channel attack may equally be effective against both page fault inducing attacks and those that track page meta-data bits and/or use cache-timing-channels.

FIG. 8 depicts a table how applications are attacked and how the numbers in the shows the efficacy of SGXL using an empirical security analysis for SGXL, in accordance with an embodiment of the present disclosure. Accordingly, to compare the performance of SGX and SGX and empirically evaluation is performed for SGXL against the SGX. There could be page-fault inducing attacks that infer secrets by differentiating the number of page faults, while others may rely on unique sequences of faults. Further, some attacks attempt to trace the code execution path while others attempt to trace accesses to data pages. In the present invention, two common metrics may be measured across all workloads to analyse the security implications of SGXL.

Firstly, the number of page faults incurred are counted, under the attack, with baseline SGX (current hardware) and SGXL. According to the measurement, if a large reduction in the number of faults is measured then it may demonstrate the efficacy of SGXL in thwarting attacks that rely on the number of page faults. However, the count may not be a good metric for attacks that instead exploit unique sequences of faults. Therefore, a number of unique bigrams in page fault address stream is measured. A larger number of unique bigrams signifies presence a larger number of unique sequences and thus, potentially more information to infer the secrets. In an embodiment, each bigram is a pair of page fault addresses that appear in the page fault stream.

For each workload, the first column describes the part(s) of the application that was traced for page faults. The next two (sub-) columns present the number of page faults incurred in baseline SGX and with SGXL, respectively. The third sub-column shows the percentage reduction in the page fault count. The next three sub-columns show the same for the number of unique bigrams. A detailed explanation of how efficient SGXL is to attacks on following applications:
FreeType: This application renders characters and the attacker an attempt to infer which character (secret) is being rendered. In this application, two key functions, (stroke and hints), are invoked a different number of times based on the character being rendered. If these two functions fall on different pages, the number of page faults can give up the secret. Thus, the attacker attacks seven relevant code pages based on offline code analysis. It does so by inducing page faults each time any of these pages are accessed by appropriately setting/un-setting the present bit in the PTEs. In Table 3 observed that SGXL eliminates more than 99.9% of the page faults and thus rending the attack useless. This is possible since a single 2 MB page can map the entire 1.5 MB code of FreeType.
Libjpeg: This application decompresses a picture, and the number of page faults is different based on whether a pixel is on the edge of a figure. By counting the number page faults, it is possible to trace the edges of the (secret) figure being decompressed. This attack requires tracking faults in all data pages. Here also observed that more than 99.7% reduction in the page fault count which easily defeats the attack. Note that the numbers of bigrams are irrelevant for attacking these two applications as they rely on page fault counts to infer secrets. However, with SGXL, even the number of unique bigrams reduces by 100% and 99.7%, respectively.
Hunspell: This application searches a preloaded dictionary for words in a document (input) for checking spellings. For each word, it hashes to a list of words that have the same hash value and then traverses the list for a match. If the nodes of a list fall on different pages, then the sequences of page faults can reveal the (secret) word being looked up. Attacker thus traces page faults on the heap and look for unique sequences of fault address to infer a word. Thus, for this application, the relevant metric is the number of unique bigrams and not the number of faults. A smaller number of unique bigrams suggests a lower likelihood of finding a sequence of faults that can uniquely identify a word. FIG. 8 shows that defence enabled in the present disclosure reduces the number of unique bigrams by more than 99.7% and thus, effective against such sequence-based attacks. Further empirically calculated the number of unique words looked up in the dictionary and the number of unique page fault sequences. A higher number of unique page fault sequences per unique words provide a better clue for inferring a word. The ratio of unique page fault sequences to the number of words is reduced by 65 when SGXL was employed. It thus becomes impossible to infer a word from the page fault sequence.
GUPS, NBench and OpenSSL: In an embodiment, similar attacks may be mounted on three micro-benchmarks. However, there were no secrets to infer in these micro-benchmarks. The only purpose here is to demonstrate the applicability of the defence across a wider number of workloads. GUPS is a micro-benchmark to create random accesses to its heap memory. Specifically, it allocates a large array whose size is parameterized and contents of which are randomly initialized. It then looks up one entry in random and updates it. Such operations are iterated a larger number of times, and consequently, generates utterly random memory accesses. Due to random jumps across the heap memory, even with the use of large page in SGXL, a relatively larger number of faults occur. However, it is found that page fault stream to be useless as the faults are across a few large pages that cover the heap (e.g., 10 s). This is also captured by a large reduction in the number of unique bigrams with SGXL. On the other hand, SGXL leaves barely any page faults or unique bigrams while executing NBench. OpenSSL library includes widely used cryptographic functions such as DES, RSA, HMAC and SHA. Monitoring access to these functions can allow an adversary to infer the operation being performed. It can be demonstrated that SGXL can reduce leakage through page faults as the entire code can fit in a single 2 MB page.

FIG. 9a illustrates an exemplary graph of speedup with SGXL under attack, in accordance with an exemplary embodiment of the present disclosure. FIG. 9a shows the speedup with SGXL when each application is under attack as described in the previously. The speedup can be calculated by dividing the execution time in the baseline SGX by that with SGXL. It is observed that SGXL speeds up first three applications undergoing real attacks FreeType, Libjpeg, and Hunspell by 3:5 to 103:5. This is excepted as the use of large pages significantly reduced the number of slow page faults (See FIG. 8). In short, SGXL not only leaves very little information for an attacker to infer secrets, but it also protects the application form performance degradation due to page fault inducing attacks.

FIG. 9b illustrates an exemplary graph of speedup with SGXL without attack, in accordance with an exemplary embodiment of the present disclosure. FIG. 9b shows the speedup when the system is not under attack. It is observed that there is barely any change in performance, except GUPS. Since there are no additional page faults due to an attack there is no scope for large performance improvement for SGXL by eliminating the extra faults. One could, however, expect that performance could have still improved due to the likely reduction in the number of TLB misses due to use of large pages. However, the memory footprints (application's memory needs to fit into EPC) of the workloads studied are too small to make any significant difference in performance.

FIG. 9c illustrates an exemplary graph projecting for larger EPC sizes with 1 GB page size, in accordance with an exemplary embodiment of the present disclosure.

In another embodiment, SGX2.0 can be expected to significantly increase the size of the EPC. A larger EPC size is essential for commercially important applications with large memory footprints, e.g., databases, to benefit from SGX. Applications with larger memory footprint also typically accompanied by larger address translation overheads. Therefore, it is believed that SGXL's use of large pages to map enclave's address space could assume further importance, not only for enhanced security but also to reduce address translation overhead, in future iterations of SGX. To understand the importance of using large pages for applications with few GBs of memory footprint and experimented with a couple of HPC programs (XSBench, CG.D), support vector machine (SVM), page rank (PR), connected components (CC) and betweenness centrality (BC). In the present invention GUPS also ran with much larger memory footprint (32 GB). FIG. 7 shows the speedups achievable for these memory-intensive applications with 1 GB large pages the largest page size available today in x86-64 processors over the default 4 KB pages. All executions are outside the enclave. The impressive speedups (1:15 to 2:36) reiterates the importance of mapping enclave memory with larger page sizes, as done in SGXL, for future versions of SGX with larger EPC.

FIG. 9d illustrates an exemplary graph of approximation of PAO by the SGXL using FreeType, in accordance with an embodiment of the present disclosure. In case of FreeType, if rendering of different characters generates a different number of faults, the attacker can infer the character. However, if every character generates the same number of faults, the attack fails. As seen in FIG. 9d, the number of unique faults remain the same with both SGXL and PAO performs the same way and leaves no unique page fault count information for an attacker to identify the pixel block being compressed.

FIG. 9e illustrates an exemplary graph of approximation of PAO by the SGXL using Libjpeg, in accordance with an embodiment of the present disclosure. Similar to performance with FreeType, the SGXL and PAO perform to leave no unique page fault count information for an attacker to identify the pixel block being compressed.

FIG. 9f illustrates an exemplary graph of approximation of PAO by the SGXL using Hunspell, in accordance with an embodiment of the present disclosure. An attack on Hunspell relies on unique page fault address sequences to identify the words being looked up. The number of unique faults sequences generated can be measured as the number of unique words being looked up also grows. SGXL closely approximates PAO, i.e., PAO generates one address pattern while SGXL generates up to a thousand unique words. Using the SGXL of the present disclosure, the secret code or data for the applications can be fit within a 2 MB page and no dummy accesses are necessary.

FIG. 9g illustrates a table presenting the results for performance of SGXL and PAO for FreeType, Libjpeg and Hunspell, in accordance with an embodiment of the present disclosure.

FIG. 10 is a high-level flow diagram illustrating working of the system for executing an enclave in a trusted execution environment on a remote computing device, in accordance with an embodiment of the present disclosure.

The process described with reference to FIG. 3 and FIG. 6 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, this processing may be performed by one or more components described with reference to FIG. 5 above.

In context of the present example, at block 1002, configuring, by a processor, the enclave by executing a first set of instructions based on configuration parameters defined by the computing device, wherein the configuration parameters comprises a pre-defined page size.

At block 1004, implementing a second set of instructions to securely copying data corresponding to the enclave in a page created in first enclave cache memory in the remote computing device, based on the configuration parameters, adding virtual page address information and page security attributes corresponding to the page in a second enclave cache memory in the remote computing device, and creating a log entry in a protected memory of the remote computing device by encrypting and saving the virtual page address information and the page security attributes, wherein the virtual page address information and the page security attributes are encrypted using a first hash key.

At block 1006, initiating the enclave by executing a third set of instructions to compare the log entry and a second hash key generated by the remote computing device.

At block 1008, dynamically adding a new page of the pre-defined size to the first enclave cache memory after the initiation of the enclave based on the plurality of configuration parameters.

At block 1010, executing the enclave at the remote computing device, by executing a fourth set of instructions based on a successful comparison of the log entry and the second hash key, wherein the success of the comparison is based on a validation of a size of the page created in first enclave cache memory in the remote computing device to be equal to the pre-defined page size.

FIG. 11 illustrates an exemplary computer system 1100 in which or with which embodiments of the present invention may be utilized. FIG. 11 illustrates an exemplary computer system 1100 in which or with which embodiments of the present invention can be utilized. As shown in FIG. 11, computer system includes an external storage device 1110, a bus 1120, a main memory 1130, a read only memory 1140, a mass storage device 1150, a communication port 1160, and a processor 1170. In one embodiment, computer system 1100 may represent some portion of an endpoint device (e.g., endpoint device 106 of FIGS. 1A-B) or computing system supporting one of the security services described herein.

Those skilled in the art will appreciate that computer system 1100 may include more than one processor 1170 and communication ports 1160. Examples of processor 1170 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 1170 may include various modules associated with embodiments of the present invention.

Communication port 1160 can be any of an RS-232 port for use with a modem based dialup connection, a 10/100 Ethernet port, a Gigabit or 10 Gigabit port using copper or fiber, a serial port, a parallel port, or other existing or future ports. Communication port 1160 may be chosen depending on a network, such a Local Area Network (LAN), Wide Area Network (WAN), or any network to which computer system connects.

Memory 1130 can be Random Access Memory (RAM), or any other dynamic storage device commonly known in the art. Read only memory 1140 can be any static storage device(s) e.g., but not limited to, a Programmable Read Only Memory (PROM) chips for storing static information e.g. start-up or BIOS instructions for processor 1170.

Mass storage 1150 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 1120 communicatively couples processor(s) 1170 with the other memory, storage, and communication blocks. Bus 1120 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 1170 to software system.

Optionally, operator and administrative interfaces, e.g. a display, keyboard, and a cursor control device, may also be coupled to bus 1120 to support direct operator interaction with computer system. Other operator and administrative interfaces can be provided through network connections connected through communication port 1160. External storage device 604 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A method for preventing a side channel attack by executing an enclave in a trusted execution environment (TEE) on a remote computing device by a computing device, the method comprising:
configuring, by a processor, the enclave by executing a first set of instructions based on a plurality of configuration parameters defined by the computing device, wherein the plurality of configuration parameters comprises a pre-defined page size;
implementing, by the processor, a second set of instructions to:
securely copying data corresponding to the enclave in a page created in first enclave cache memory in the remote computing device, based on the plurality of configuration parameters,
adding virtual page address information and page security attributes corresponding to the page in a second enclave cache memory in the remote computing device, and
creating a log entry in a protected memory of the remote computing device by encrypting and saving the virtual page address information and the page security attributes, wherein the virtual page address information and the page security attributes are encrypted using a first hash key;
initiating the enclave by executing a third set of instructions to compare the log entry and a second hash key generated by the remote computing device;
dynamically adding a new page of the pre-defined size to the first enclave cache memory after the initiation of the enclave; and,
executing the enclave at the remote computing device, by executing a fourth set of instructions based on a successful comparison of the log entry and the second hash key, wherein the successful comparison is based on a validation of a size of the page created in first enclave cache memory in the remote computing device to be equal to the pre-defined page size.

2. The method of claim 1, wherein the pre-defined page size is 2 GB.

3. The method of claim 1, wherein the first hash key is computed by executing a fifth set of instructions based on the pre-defined page size and a content associated to the page.

4. The method of claim 1, wherein the second hash key is created by the remote computing device based on at least one of the configuration parameters.

5. The method of claim 4, wherein the second hash key is created based on at least one of the configuration parameters comprising a page size, the virtual page address information and the security attributes.

6. The method of claim 1, wherein the configuration parameters comprise a mapping between the virtual page address information of one or more pages created and the first enclave cache memory.

7. The method of claim 6, wherein the remote computing device generates the virtual page address information based on the mapping included in the configuration parameters when the enclave is initiated.

8. The method of claim 1, the new page is added in the first enclave cache memory by executing a sixth set of instruction after the initiation of the enclave.

9. The method of claim 8, wherein the new page is created in a pending state.

10. The method of claim 9, wherein the new page is accepted by the enclave by executing a seventh set of instruction.

11. A system for executing an enclave in a trusted execution environment to prevent a side channel attack, the system comprising:
a client computing device communicably connected to a remote computing device implementing the trusted execution environment; wherein the client computing device comprises a memory and a processor configured to:
configure the enclave by executing a first set of instructions based on a plurality of configuration parameters defined by the computing device, wherein the plurality of configuration parameters comprises a pre-defined page size;
implement a second set of instructions to:
securely copy data corresponding to the enclave in a page created in first enclave cache memory in the remote computing device, based on the plurality of configuration parameters,
add virtual page address information and page security attributes corresponding to the page in a second enclave cache memory in the remote computing device, and
create a log entry in a protected memory of the remote computing device by encrypting and saving the virtual page address information and the page security attributes, wherein the virtual page address information and the page security attributes are encrypted using a first hash key;
initiate the enclave by executing a third set of instructions to compare the log entry and a second hash key generated by the remote computing device;
dynamically add a new page of the pre-defined size to the first enclave cache memory after the initiation of the enclave; and,
execute the enclave at the remote computing device, by executing a fourth set of instructions based on a successful comparison of the log entry and the second hash key, wherein the success of the comparison is based on a validation of a size of the page created in first enclave cache memory in the remote computing device to be equal to the pre-defined page size.
